(19) United States
(12) Patent Application Publication
(10) Pub. No.: US 2023/0409849 A1
(43) Pub. Date: Dec. 21, 2023

(54) CONTACTLESS READER

(71) Applicant: IFPL Group Limited, Isle of Wight, Hampshire (GB)

(72) Inventors: Geoffrey UNDERWOOD, Isle of Wight, Hampshire (GB); Marek SZROK, Isle of Wight, Hampshire (GB)

(21) Appl. No.: 18/044,623

(22) PCT Filed: Sep. 9, 2021
(86) PCT No.: PCT/GB2021/052328

§ 371 Date: Mar. 9, 2023

(30) Foreign Application Priority Data
Sep. 9, 2020 (GB) 2014141.2

(51) Int. Cl. G06K 7/10; B64D 11/06

(52) U.S. Cl. CPC G06K 7/10415; B64D 11/06

(57) ABSTRACT

A contactless credential reader which is arranged to be installed in a rearward portion of a passenger seat of a transportation vehicle, such as an aircraft, in which the reader is arranged to be capable of being installed as either a rear mount or as a front mount.

### TECHNICAL FIELD

The present invention relates generally to contactless readers.

### BACKGROUND

Near-Field-Communication (NFC) is a set of established communication protocols for communication between two electronic devices over a distance of 4 cm or less (this could be greater than 4 cm however the field strength is only measured up to 4 cm). NFC readers are known which allow a payment device to be presented in proximity of the reader and to obtain payment credential data from the payment device by way of inductive coupling. The reader has an antenna which emits a field. This is received by an antenna of the payment device which in turn causes the data stored on the device to be conveyed to the reader.

When installing multiple readers (say, one for each passenger) in a mass transportation vehicle, such as a passenger aeroplane, we have realised that various issues could arise. We therefore seek to provide an improved contactless payment reader for use in relation to a passenger cabin of an aircraft. Contactless payment terminals can be used in this context to allow passengers to pay for goods and/or services, which may be displayed/offered on a display device such as a screen.

### SUMMARY

According to a first aspect of the invention there is provided a contactless credential reader which is arranged to be installed in a rearward portion of a passenger seat of a (mass) transportation vehicle, such as an aircraft, in which the reader is arranged to be capable of being installed as either a rear mount or as a front mount.

The reader may comprise a unit or carcass which comprises a housing, and the housing contains processing electronics. The unit or carcass may be a sealed entity.

The housing may be arranged to receive an antenna on top of or an external surface of the housing.

The housing may be a welded housing.

In a rear mount installation, the reader is located behind a rearward panel of the passenger seat, said panel is preferably an integral part of the seat at the time of manufacture.

In a front mount installation, a frontmost/foremost surface thereof sits within a hole or cut-out provided in the rearmost panel of the seat, and said frontmost surface may be located flush or substantially so, with said rearmost panel.

The frontmost portion of the terminal may comprise an antenna.

In a front mount installation, a fascia may be provided forwardly of the frontmost surface of the reader, which fascia may be attached to the rearward panel of the passenger seat. The fascia may be provided outwardly of the rearward panel of the passenger seat. The fascia may be arranged to protrude outwardly of the rearward panel of the seat.

The fascia may be made of substantially the same material as that of the panel of the passenger seat.

The reader may include a fascia, which is arranged to be located such that it is the foremost part of the reader.

The fascia may comprise a thickness which is substantially that of a passenger seat panel. The thickness may be in range 2.5 mm to 3.5 mm, and may be 3 mm. The range may be 3.15 mm to 2.85 mm).

The material of the fascia is substantially the same or similar material as the material of the panel of the passenger seat.

The reader may comprise an antenna, a memory and/or a processor.

The reader may include a processor, such as a microprocessor.

The reader may comprise circuitry which is arranged to process a payment credential.

The reader may be termed a contactless terminal (in EMV terms this is an ‘Intelligent Card Reader (ICR) and may not be considered a terminal which applies to the broader system). The reader may be termed a contactless payment terminal.

By contactless credential reader we include implementation of an NFC protocol or similar. Broadly, by ‘contactless’ we include

The reader may be arranged for use which one or more of the following devices:
Bank card
Credit card
Mobile phone
PED—portable electronic device
Tablet computer
Fob
Physical token

Each of the above devices may comprise circuitry which includes an antenna, and stored credential data. Each of the devices may include a microprocessor (chip).

The invention may comprise one or more features as shown in the Figures and/or as described in the description, either singularly or in combination.

The reader may include a welded housing.

A further aspect of the invention includes a passenger seat which includes the reader of the above aspect of the invention, installed as a rear mount or a front mount.

### BRIEF DESCRIPTION OF THE DRAWINGS

One or more embodiments of the invention are shown in the drawings:

FIG. 1 is a series of perspective views in which various assembly stages of a contactless payment reader are shown,

FIG. 2 shows two sets of representations in which one set shows a front mount installation and a second set shows a rear mount installation, of the contactless payment terminal, and

FIG. 3 shows further views of the two types of install.

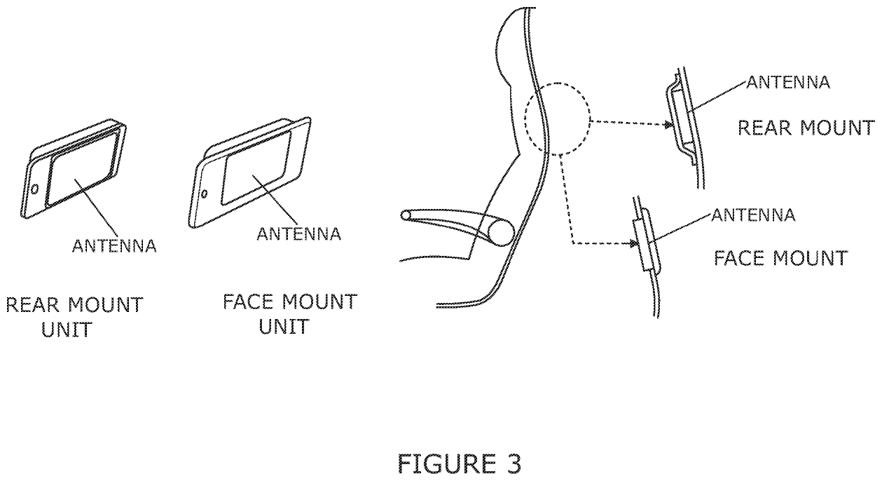

### DESCRIPTION

Reference is made to the Figures in which an exemplary embodiment of a contactless payment terminal is shown. The payment terminal is arranged be installed for use in one of two ways, namely a front mount configuration or a rear mount configuration.

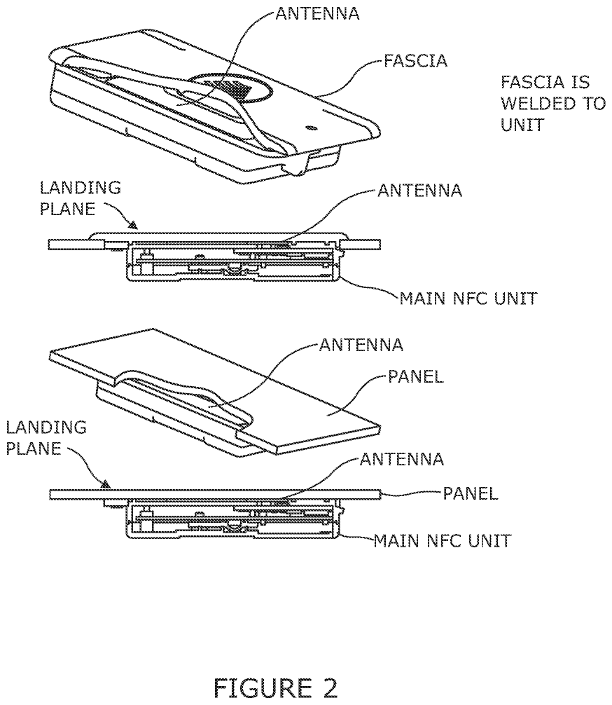

The payment terminal contains circuitry which enables a payment credential to be read when brought into proximity with an antenna of the terminal. The antenna is a printed circuit board with a precise geometrical track formed as a copper strip formed as a flat coil within a circuit board. It has two exposed surface contacts that connect to the payment electronics contained within the welded housing via two spring pins that push against the exposed contacts. The terminal may also include one or more processors to drive the functionality of the terminal. The processor(s)/payment electronics, or more generally the electronic componentry is contained internal of the housing, as best seen in FIG. 2.

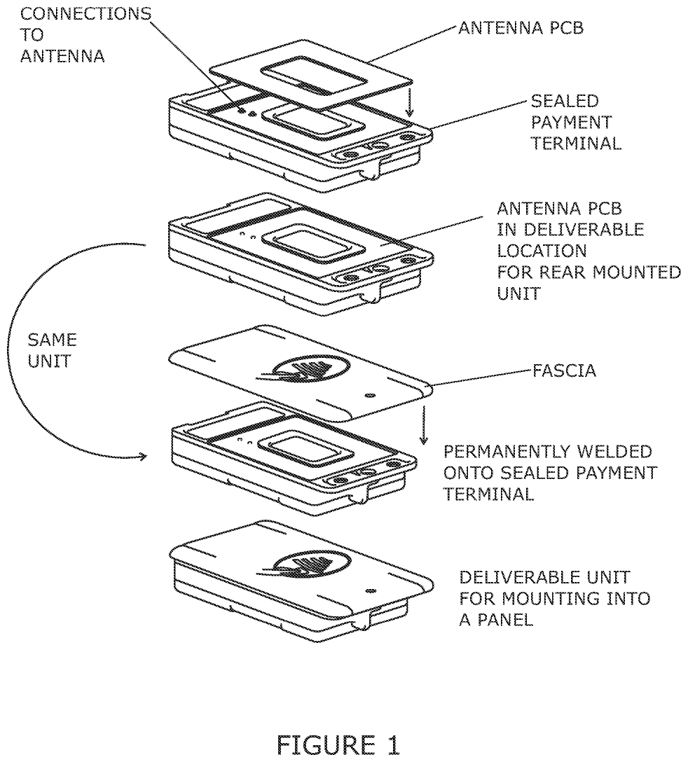

With reference to FIG. 1, there is shown in stepwise fashion the way in which a contactless reader can be assembled. In FIG. 1, a fascia is included which is arranged for use with a front mounted install to a passenger seat.

In FIG. 2, the top two images are that of the terminal in front mounted install. In the lower two images in FIG. 2 there are shown a rear mounted install. It is to be noted that save for the use of the fascia in the front mount install, the main ‘carcass’ of the terminal is one and the same (which includes the housing which contains/supports the electronics of the reader, such as the circuit board). No fascia is required for the rear mount install, in which the terminal sits behind a panel of the passenger seat. A protective or covering label can be placed onto the antenna.

In the front mounted install the unit sits in a hole in the panel and the fascia component is welded to the unit encapsulating the antenna and therefore prevents access to the unit (and its innards) behind.

The thickness of the fascia is advantageously intended to be of the same or substantially the same thickness, and of the same or similar material, as that of the panel of the passenger seat. This means that the main or carcass part of the terminal can be used for both rear mount and front mount installs, since the antenna has the same thickness of material to push the electromagnetic field through.

In the classic case for payment terminals the end use scenario (how and/or where it is be installed etc) is defined at the outset of development. The end use case determines the location of the payment antenna with respect to both the user of the terminal and the person paying for the goods or service.

However, within the aircraft industry this advanced knowledge is seldom known and therefore the use case can only be guessed at. As far as the location is concerned, the payment terminal may be horizontal, vertical, behind a seat panel or in front of a panel. The challenge which has been overcome by the above-described payment terminal is providing a single terminal that can advantageously be used in the majority of cases.

The above contactless payment terminal can be installed in many different locations by providing a single antenna system, no matter if the unit fits behind a panel or indeed sits in front of a panel. Different passenger seats can be constructed differently, with some allowing only a front mount install and others allowing only a rear mount install.

The datum point for the field measurement process is critical to the certification of the unit. In most situations the device is designed so that the antenna is in a controlled and known attitude. This allows any attenuation of the magnetic field by the casing to be considered at the design stage and therefore the electronics, the antenna and the casing geometry can be controlled to provide the optimum allowable magnetic field. In an aircraft situation the orientation of the device, the plane in which it sits and more importantly the position of the antenna with respect to the landing plane are installation dependent (space, Head Impact Criteria, cable runs etc). The above described reader allows for behind panel and in front of panel situations (as described above) as a function of design thereby ensuring the position of the antenna relative to the landing plane. In this way, every different installation does not need to be re-certified, thus avoiding the significant time and financial costs.

1. A contactless credential reader which is arranged to be installed in a rearward portion of a passenger seat of a transportation vehicle, such as an aircraft, in which the reader is arranged to be capable of being installed as either a rear mount or as a front mount.

2. A contactless reader as claimed in claim 1 in which in a rear mount installation, the reader is located behind a rearward panel of the passenger seat, and said panel is an integral part of the seat at the time of manufacture.

3. A contactless reader as claimed in claim 1, in which, in a front mount installation, a frontmost/foremost surface thereof sits within a hole or cut-out provided in the rearmost panel of the seat, and said frontmost surface is located flush or substantially so, with said rearmost panel.

4. A contactless reader as claimed in claim 3 in which the frontmost portion of the terminal comprises an antenna.

5. A contactless reader as claimed in claim 1 in which in a front mount installation, a fascia may be provided forwardly of the frontmost surface of the reader, which fascia is attached to the rearward panel of the passenger seat.

6. A contactless reader as claimed in claim 5 in which the fascia is provided outwardly of the rearward panel of the passenger seat.

7. A contactless reader as claimed in claim 6 in which the fascia is arranged to protrude outwardly of the rearward panel of the seat.

8. A contactless reader as claimed in claim 5 in which the fascia is made of substantially the same material as that of the panel of the passenger seat.

9. A contactless reader as claimed in claim 1 which comprises a reader which includes a fascia, which is arranged to be located such that it is the foremost part of the reader.

10. A contactless reader as claimed in claimed 9 in which the fascia comprises a thickness which is substantially that of a passenger seat panel.

11. A contactless reader as claimed in claim 10, in which the thickness is in range 2.5 mm to 3.5 mm.

12. A contactless reader as claimed in claim 1 which comprises an antenna, a memory and/or a processor.

13. A contactless reader as claimed in in claim 1 which comprises a housing which contains payment electronics and/or one or more processors to drive functionality of the reader, and which reader is arranged to be installed (selectively) as a rear mount installation and a front mount installation.

14. A contactless reader which comprises a housing which contains the payment electronics and/or one or more processors.

15. A contactless reader as claimed in in claim 1 which is a contactless payment terminal.
